(19) United States
(12) Patent Application Publication
(10) Pub. No.: US 2004/0008413 A1
(43) Pub. Date: Jan. 15, 2004

(54) Method for manufacturing complex grating masks having phase shifted regions and a holographic set-up for making the same

(75) Inventors: Francois Trepanier, Cap-Rouge (CA); Michel Poulin, Quebec (CA)

Correspondence Address: DARBY & DARBY P.C., P. O. BOX 5257, NEW YORK, NY, 10150-5257, US

(73) Assignee: Teraxion Inc., Sainte-Foy (CA)

(21) Appl. No.: 10/431,343

(22) Filed: May 6, 2003

(30) Foreign Application Priority Data
May 7, 2002 (CA) 2,385,118

(51) Int. Cl. G02B 27/64

(52) U.S. Cl. 359/557

(57) ABSTRACT

A method for manufacturing complex gratings masks having phase shifted regions and a holographic set-up for making the same are disclosed. The method, which can be easily automated, allows to produce arbitrary phase shift in holographically recorded gratings with high precision. In a preferred embodiment, the phase is controlled by a fringe locking system with a movable locking detector and a phase measuring device such as a camera for example, thereby allowing to provide a real-time phase locking and a real-time calibration of the set-up.

### FIELD OF THE INVENTION

The present invention relates to the fabrication of optical components and more particularly concerns grating masks and a method for the fabrication of complex phase masks having multiple phase shifts.

### BACKGROUND OF THE INVENTION

An efficient basic method for the fabrication of fiber Bragg gratings is the phase mask method by Hill et al. disclosed in U.S. Pat. No. 5,367,588. This technique employs a silica phase mask to generate two diffracted beams of UV light that overlap on an optical fiber, creating the grating in the core of this fiber.

The requirements on performances for fiber Bragg grating filters ask for complex apodisation profiles of the grating written into the core of the fiber. A complex apodisation profile consists in a variation of the strength (refractive index amplitude modulation) of the grating along the length of the fiber and phase shifts within the same grating.

For example, using a regular uniform phase mask, the complex apodisation profile can be obtained by using a variable dither of the phase mask position using a piezoelectric stage during the writing of the Bragg grating, such as shown in U.S. Pat. No. 6,072,976 (COLE et al.).

An alternative method is shown in U.S. Pat. No. 6,307,679 (KASHYAP) where complex apodisation profiles were realized using a standard phase mask with multiple exposures and variable control tension on the fiber from exposure to exposure creating a Moiré pattern.

Even though these techniques work well, they require complex computer controlled recording systems.

The ideal technique would include a phase mask in which the phase shifts are already incorporated, thus allowing recording of Bragg gratings using simple illumination without any computer control. Usually the required phase shift in the Bragg grating has a value of π (half a period). Since the phase mask method usually employs the interference between both first orders of diffraction, there is typically a reduction of two from the pattern of the phase mask to the interference pattern forming the Bragg grating. For example, a phase mask of period Λ will produce a Bragg grating of period Λ/2. Since the interference pattern is fixed relative to the phase mask, a π phase shift in the interference pattern corresponds to a π/2 phase shift of the phase mask fringes. The required phase shift in the phase mask must thus be of a quarter of the phase mask period.

A relatively easy way to manufacture phase shifted phase mask is by using direct writing techniques such as e-beam or ion beam systems, such as shown by Pakulski et al. in “Fused silica mask for printing uniform and phase adjusted gratings for distributed feedback laser”, Appl. Phys Lett., 62 (3), 1993, pp 222-223. In those systems, each individual line of the grating is written one after another using high precision computer control scanning system and the local phase of the grating may thus be easily adjusted. The drawback of direct writing systems is the known stitching effect from the scanning writing beam causing undesired spectral response for the Bragg grating. Also, the process is usually quite long since each line is written individually, especially for long gratings.

Holographically recorded phase masks are highly preferred over e-beam or ion beam phase masks since they do not exhibit any stitching effects. However, it is not easy to implement phase shifts in them. Many techniques have been disclosed for producing holographic phase shifted gratings. Some of them are using a combination of positive and negative photoresists or special photolithographic processes to implement phase reversal in some areas of the grating. Different variants of such techniques are for example shown in U.S. Pat. Nos. 4,660,934 (AKIBA et al.), 4,826,291 (UTAKA et al.), 4,885,231 (CHAN), 5,024,726 (FUJIWARA) and 5,236,811 (FUJIWARA). The main advantage of these techniques is that they require only one holographic exposure and the phase shift is exact. However, it is limited only to π phase shift and the properties of the grating is not exactly the same in both phase area since the etching processes are different for both phases in order to obtain phase reversal.

Referring to U.S. Pat. No. 5,221,429 (MAKUTA), there is shown another technique using a phase shifting element applied on the photoresist before exposure to provide a phase shifted region under asymmetrical exposure geometry. Again, this technique has the advantage of requiring a single exposure. Also any phase shift can be obtained by varying the thickness of the phase shifting element or by changing the asymmetry of the exposure beams. The drawback is that it requires a complex process to produce the required precise phase shifting element on the photoresist coated plate. Also, light impinging on the edge on the phase shifting element may generate parasitic illumination of the photoresist and transition zones which are not well defined. Finally, this element should be perfectly anti-reflection coated to prevent the generation of a parasitic grating superposed to the desired grating.

Phase shifting elements have also been used away from the photoresist and placed in one of the interfering beams, for example in U.S. Pat. Nos. 4,792,197 (INOUE et al.) and 4,806,454 (Yoshida et al.). By having a patterned phase shifting plate in one arm, phase shifted regions are recorded in the photoresist. In order to avoid diffraction effects, imaging lenses can be used. For this technique, a proper thickness must be used and precise angular position of the phase shifting element is very critical.

Johansson et al. (“Holographic diffraction gratings with asymmetrical groove profiles”, Applications of holography and optical data processing, pp. 521-530, 1976) and MacQuigg (“Hologram fringe stabilization method”, Appl. Opt., Vol. 16, No. 2, pp. 291-292, February 1977) proposed to use a Moiré effect between the interfering beams and a previously recorded grating using the same beams as a mean to observe the relative phase between these beams. In essence, an auxiliary hologram (or phase control grating) is recorded, developed and put back in place. When rotated through a small angle about an axis parallel to the grating lines, straight equally spaced fringes are generated. A detector, placed in the beam on the backside of the control grating, is used to control the phase of the fringes using lock-in techniques or other control electronics. It is proposed that the control grating be translated perpendicular to the fringes to achieve phase control. A displacement of one grating period is indeed needed to change the phase by 360°. The precision on the phase shift obtained by MacQuigg is around 10°. One minor disadvantage is that a new auxiliary grating must be generated each time the interferometer configuration is changed.

Real-time recorded holograms in photorefractive crystals may also be used for generating the Moiré fringes used for stabilization, as described by Kamshilin et al. (“Photorefractive crystals for the stabilization of the holographic setup”, Appl. Opt., Vol. 25, No. 14, pp. 2375-2381, July 1986). However, such scheme suffer from long-term drift of the locking point as the phase control grating is affected by all the perturbations occurring during the recording process.

Locking techniques enable to realize a phase shift of π/2 in a simple way (see for example Frejlich et al. “Analysis of an active stabilization system for a holographic setup”, Appl. Opt., Vol. 27, No. 10, pp. 1967-1976, May 1988). To this end, a phase modulation is added onto one of the beam of the interferometer usually through a piezoelectric transducer. A photodiode is placed in the region where the Moiré pattern is generated. The detected signal is demodulated with a lock-in amplifier. When demodulation is done with the same frequency as the one used for modulation, the locking occurs onto a dark or bright fringe, depending of the phase of the reference at the demodulator input. If 2f detection is used (demodulation at twice the modulation frequency), the locking point will be shifted by π/2 relative to the one in If demodulation. Error signal in the case of 1f demodulation is proportional to the first derivative of the fringe intensity pattern while for 2f demodulation it is proportional to its second derivative. If a sinusoidal function can be used to describe the Moiré fringes, the locking point will be a zero of a cosinusoidal function for if demodulation and a zero of a sinusoidal function for 2f demodulation. Since sine and cosine functions are offset by a phase of π/2, such a phase difference will be recorded between the successive exposures. Exact π/2 phase shift will be generated if only a really sinusoidal Moiré fringe pattern is generated. The phase shift will be affected by departure from perfectly sinusoidal fringes, i.e. distortion of the shape of the fringes. This technique is limited to locking to either 0, π or ±π/2 phase difference relative to the first recording.

Little (“Phase stabilization and control technique with improved precision”, Appl. Opt., Vol. 25, No. 12, pp. 1871-1872, June 1986) proposed to achieve greater accuracy in phase control by translating the feedback loop detector instead of the phase control grating itself. As the period of the Moiré fringes is on the order of 10³ to 10⁴ the period of the phase control grating, a phase settability of 1° or better can then be obtained easily. Also, arbitrary phase difference can be set. Again, locking can be done using lock-in techniques or with a dual photodetector and a differencing scheme. In this approach, the phase of the fringes is previously calibrated using a second detector placed inside the Moiré fringe pattern. A calibrating curve is generated, giving the voltage at the output of this detector as a function of the position of the translated detector used for locking. The phase is set using this calibration curve. A disadvantage is that this calibration is done prior to the recording and is dependent on the laser power as the calibration signal is taken at the detector output.

### OBJECTS AND SUMMARY OF THE INVENTION

It is therefore an object of the present invention to provide a method for producing arbitrary phase shift in holographically recorded gratings overcoming the drawbacks of prior art techniques.

It is another object of the present invention to provide a holographic grating mask incorporating phase shifts.

Accordingly, there is provided a method for manufacturing a grating mask having phase shifted regions, the method comprising the steps of:

a) providing a first mask and a second mask, each of the masks having at least one opaque area and at least one transparent area;

b) masking by the first mask a photosensitive substrate for providing a first substrate-mask assembly;

c) placing the first substrate-mask assembly in a recording area of a holographic set-up provided with a plurality of coherent interfering laser beams producing primary interference fringes having a phase;

d) locking the phase of the primary fringes relative to the photosensitive substrate with a fringe control system comprising:

a reference grating placed in the recording area for producing Moiré fringes having a phase;

a Moiré fringes sensing device exposed to the Moiré fringes for sensing the phase of the Moiré fringes;

processing means connected to the Moiré fringes sensing device for processing the phase of the Moiré fringes;

the processing means being connected to a phase shifting device shifting a phase of one of the laser beams for shifting the phase of the primary fringes, thereby locking the phase of the primary fringes relative to the photosensitive substrate during an exposure of the photosensitive substrate;

e) exposing the first substrate-mask assembly to the locked primary fringes of the holographic set-up for recording the primary fringes in the photosensitive substrate through the at least one transparent area of the first mask;

f) stopping exposing;

g) removing the first mask of the photosensitive substrate;

h) masking by the second mask the photosensitive substrate for providing a second substrate-mask assembly;

i) shifting of a predetermined distance the phase of the primary fringes relatively to the photosensitive substrate with the phase shifting device for providing a primary fringes phase shift;

j) locking the phase of the primary fringes relatively to the photosensitive substrate with the fringes control system;

k) exposing the second substrate-mask assembly to the locked primary fringes of the holographic set-up for recording the primary fringes in the photosensitive substrate through the at least one transparent area of the second mask, thereby providing a grating mask having phase shifted regions.

It is a preferable object of the present invention to provide a method using a real time calibration system for determining the distance that the detector needs to be translated for achieving a desired phase shift.

It is another preferable object of the present invention to provide a method wherein the calibration is independent of the laser power as may be obtained by use of a real-time camera for analyzing the Moiré fringe pattern.

It is another object of the present invention to provide a holographic set-up for manufacturing grating masks incorporating phase shifts.

Accordingly, there is provided a holographic set-up for manufacturing a grating mask having phase shifted regions, on a recording plate. The holographic set-up is provided with a plurality of coherent interfering laser beams producing primary interference fringes having a phase in a recording plane. The recording plate is coincident to the recording plane. The holographic set-up is also provided with a fringe control system for controlling the phase of the primary interference fringes. The fringes control system is provided with a reference grating placed in the area of the recording plane for producing Moiré fringes having a phase. The fringes control system also has a Moiré fringes sensing device exposed to the Moiré fringes for sensing the phase of the Moiré fringes. The fringes control system is also provided with processing means connected to the Moiré fringes sensing device for processing the phase of the Moiré fringes, thereby locking the phase of the primary fringes relative to the recording plate during an exposure of the recording plate to the primary fringes and shifting the phase of the primary fringes between multiple exposures of the recording plate to the primary fringes. Finally, the holographic set-up is provided with a phase shifting device connected to the processing means for shifting a phase of one of the laser beams, thereby shifting the phase of the primary fringes in the recording plane.

Other aspects and advantages of the present invention will be better understood upon reading preferred embodiments thereof with reference to the appended drawings.

### BRIEF DESCRIPTION OF THE DRAWINGS

These and other objects and advantages of the invention will become apparent upon reading the detailed description and upon referring to the drawings in which:

FIG. 1 is a schematic representation of a holographic set-up for manufacturing a grating mask having phase shifted regions, according to a preferred embodiment of the present invention.

FIG. 2 shows a multiple π/2 phase shift mask realized according to the method of the present invention.

FIG. 3 shows the theoretical reflectivity spectrum of a Bragg grating realised with the multiple π/2 phase shift mask shown in FIG. 2.

FIG. 4 shows an experimental reflectivity spectrum of a Bragg grating realised with the multiple π/2 phase shift mask shown in FIG. 2.

While the invention will be described in conjunction with an example embodiment, it will be understood that it is not intended to limit the scope of the invention to such embodiment. On the contrary, it is intended to cover all alternatives, modifications and equivalents as may be included as defined by the appended claims.

### DETAILED DESCRIPTION OF PREFERRED EMBODIMENTS

The present invention concerns a method for producing arbitrary phase shifts in holographically recorded gratings without the use of phase shifting plate nor any special photoresist processing. Such a method can be used for manufacturing waveguide gratings requiring complex apodisation profiles including phase shifts.

The principle of using multiple expositions is efficient in the present method because the phase is controlled by a fringe locking system allowing repeatable phase between exposures. These multiple expositions can be usually processed very rapidly and eliminate the need for complex photoresist or etching processing and the insertion of high precision phase shifting element in the exposing beams. Therefore, this method can be easily automated, thereby providing precise gratings at an affordable cost.

The present method improves the method of Little described above by adding a real-time calibration system and/or by rendering the calibration independent of the laser power. If, instead of using the output of an auxiliary detector to measure the calibration voltage, its output is demodulated in a second lock-in amplifier, one removes the dependence of the calibration on the laser power. One can also avoid to use an auxiliary detector and an additional lock-in amplifier as this signal is already available on the photodetector used for the locking purpose (in the scheme of Little). A second approach is to use an independent camera to monitor in real-time the Moiré fringes pattern. Their period can then be measured at the time of recording and the spatial displacement needed for a particular phase shift calculated. It is to be understood that throughout the present description, the expression “phase shift” is intended to mean that the fringes are shifted regarding a particular plane. Indeed, when a phase shift is operated, it means that the position of the fringes regarding the particular plane is modified.

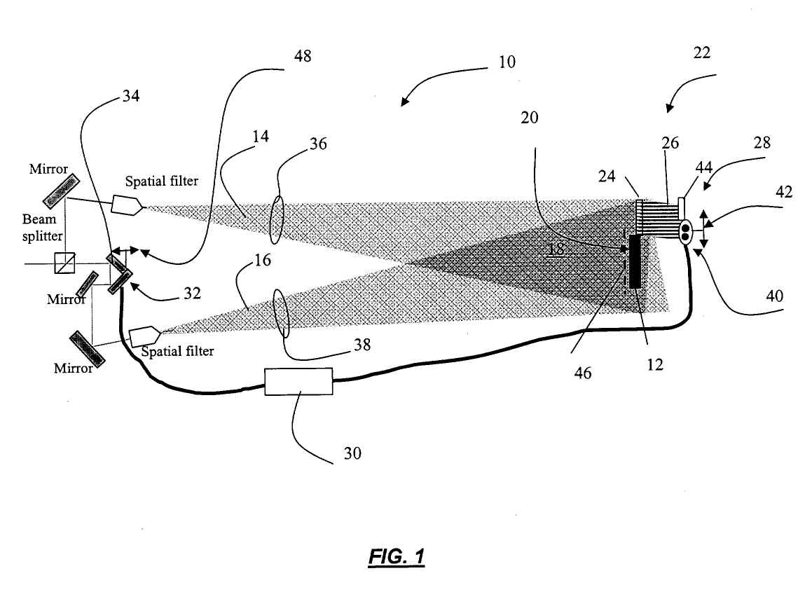

FIG. 1 illustrates a preferred embodiment of a holographic set-up 10 used for manufacturing a grating mask having phase shifted regions. The grating mask is manufactured according to the following steps:

a) A first mask and a second mask are provided. Each of the masks has at least one opaque area and at least one transparent area. Preferably, the transparent areas of the masks are clear openings without any material. More preferably, each of the transparent areas of the first mask is masked by one of the opaque regions of the second mask. However, for a particular complex grating mask, other distributions of opaque and transparent areas may also be envisaged. In a preferred embodiment of the invention, the first and second masks are provided within a single masking element 46.

b) A photosensitive substrate 12 is masked by the first mask for providing a first substrate-mask assembly. Advantageously, the photosensitive substrate is a photoresist coated substrate, and more advantageously, the substrate may be made of material selected from the group consisting of silica, silicon, glass, magnesium fluoride, calcium fluoride and zinc selenide. However, any convenient photosensitive material could also be envisaged. Photoresist may be of positive or negative type.

c) The first substrate-mask assembly is placed in a recording area of a holographic set-up 10 provided with a plurality of coherent interfering laser beams 14, 16 producing primary interference fringes 18 having a phase. In the preferred embodiment illustrated in FIG. 1, only two laser beams are shown but it should be understood that any number of laser beams could be used according to a particular application.

d) The phase of the primary fringes 18 is then locked relative to the photosensitive substrate 12 with a fringe control system 22. Such a fringe control system 22 permits to assure the stability of the primary fringes 18 during the exposure. The fringes control system 22 is provided with a reference grating 24 placed in the recording area, preferably near the photosensitive substrate 12, for producing Moiré fringes 26 having a phase. Preferably, the Moiré fringes 26 have a periodicity ranging between 2 mm and 5 mm. In fact, the Moiré fringes 26 act as an expansion of the primary fringes 18 to achieve higher precision in the control of the primary interference fringes 18. The fringes control system 22 is also provided with a Moiré fringes sensing device 28 exposed to the Moiré fringes 18 for sensing the phase of the Moiré fringes 18. The fringes control system 22 also has processing means 30 connected to the Moiré fringes sensing device 28 for processing the phase of the Moiré fringes 26. The processing means 30, which can be a computer or any convenient electronic system, is connected to a phase shifting device 32 shifting the phase of one of the laser beams 14, 16 for shifting the phase of the primary fringes 18, thereby locking the phase of the primary fringes 18 relative to the photosensitive substrate 12 during an exposure of the photosensitive substrate 12.

In the preferred embodiment illustrated in FIG. 1, the phase shifting device 32 includes a moving mirror 34 (or a corner reflector), preferably mounted on a piezoelectric translation stage 48, extending in a path of one of the laser beams 14, 16 for shifting the phase of the laser beam.

In other words, since the Moiré fringes act as an expansion of the primary fringes, a phase shift in the Moiré fringes is exactly the same as in the primary fringes. Thus, in locking the Moiré fringes to a particular position, one locks the primary fringes to a particular position with a very high precision.

e) The first substrate-mask assembly is exposed to the locked primary fringes 18 of the holographic set-up 10 for recording the primary fringes 18 in the photosensitive substrate 12 through the transparent areas of the first mask.

f) The exposure is then stopped.

g) The first mask is removed from the photosensitive substrate 12 surface.

h) The photosensitive substrate 12 is masked by the second mask for providing a second substrate-mask assembly. Advantageously, the first and second masks are provided within a single masking element 46 which can be easily translated in front of the photosensitive substrate 12 in order to achieve a better automation of the present method.

i) The phase of the primary fringes 18 is shifted of a predetermined value relatively to the photosensitive substrate 12 with the phase shifting device 32 for providing a primary fringes phase shift.

Different techniques can be used for achieving the phase shift. In a first preferred embodiment which is illustrated in FIG. 1, the Moiré fringes sensing device 28 is provided with a locking detector 40 mounted on a translation stage 42. Since the Moiré fringes 26 are locked (fixed) to the position of the locking detector 40 and the phase shift in the Moiré fringes 26 is exactly the same as in the primary fringes 18, the phase shift is realised by translating this locking detector 40 by a predetermined distance. This predetermined distance d can be calculated from the pitch A of the Moiré fringes 26. If the desired phase shift is φ, then the distance is calculated from the following equation:

$$d = φ \frac{Λ}{2 π} .$$

This equation implies that the pitch Λ is measured in a plane parallel to the direction of the translation. Consequently, the locking detector 40 is preferably translated in a plane parallel to the photosensitive substrate 12 for simplifying processing but other arrangements could also be used and are believed to be within the scope of the present invention.

In a second preferred embodiment, the Moiré fringes sensing device 32 is further provided with a fixed camera 44 (CCD array or matrix for example) exposed to the Moiré fringes 26 and connected to the processing means 30 for analyzing Moiré fringes 26. In order to be more precise for the phase adjustment, instead of moving the locking detector 40 a predetermined calculated distance, we can move it until an adequate phase shift is measured. The phase shift can be measured by analyzing the movement of the Moiré fringes 26 while the locking detector 40 is moved. The movement of the Moiré fringes can be precisely analysed by the fixed camera 44. This configuration allows simultaneous very efficient fringe locking and precision measurement of the phase shift.

In a third preferred embodiment, the camera 44 could also be used as the fringe locker detector. In that case, one would not move the detector 44 (camera) but only the moving mirror 34 until the desired phase shift is measured on the camera 44. The drawback is that the camera 44 usually requires some processing time to evaluate the phase of the Moiré fringes 26 so the fringe locking would not be as fast and efficient as by using a properly designed independent locking detector providing real time error signal.

j) The phase of the primary fringes 26 is then locked relatively to the photosensitive substrate 12 with the fringes control system 22.

k) The second substrate-mask assembly is then exposed to the locked primary fringes 26 of the holographic set-up 10 for recording the primary fringes 26 in the photosensitive substrate 12 through the transparent areas of the second mask, thereby providing a grating mask having phase shifted regions.

The grating mask can then be processed according to usual fabrication techniques for the desired type of grating.

Advantageously, the grating mask can be chirped, linearly or not, or unchirped. The final processed grating mask can be an apodised grating or even a phase mask for the fabrication of Bragg grating.

The method has been described using two different masks but if other areas having different phase shift are desired, the steps f) to k) may be repeated using proper additional masks.

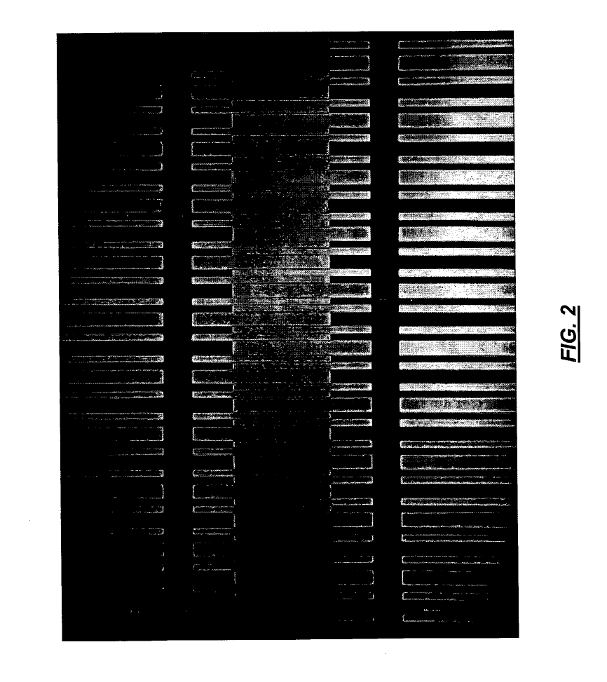

FIG. 2 shows a multiple π/2 phase shift mask realized according to the method of the present invention.

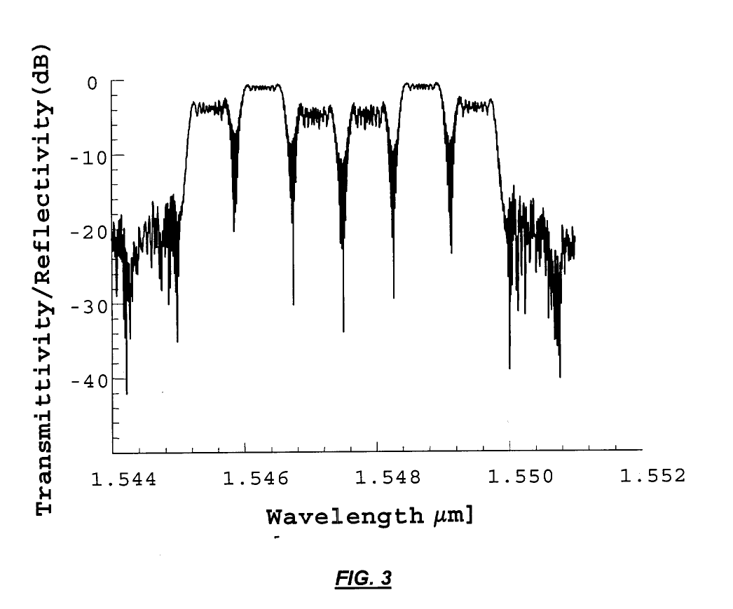

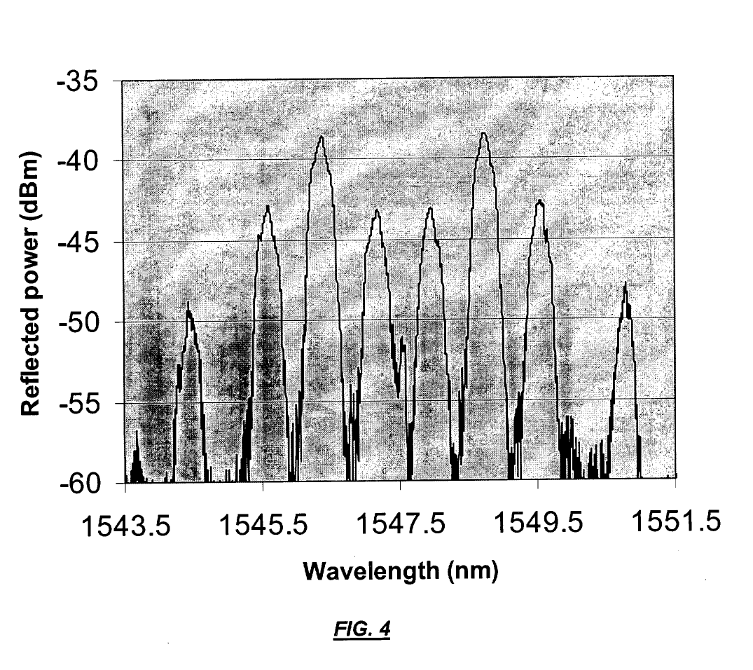

FIG. 3 shows the theoretical reflectivity spectrum of a Bragg grating realized with the multiple π/2 phase shift mask shown in FIG. 2 while FIG. 4 shows the experimental reflectivity spectrum.

Referring again to FIG. 1, the illustrated holographic set-up 10 for manufacturing a grating mask having phase shifted regions, on a recording plate 12, is provided with a plurality of coherent interfering laser beams 14, 16 producing primary interference fringes 18 having a phase in a recording plane 20. The recording plate 12 is coincident to the recording plane 20. The holographic set-up 10 is also provided with a fringe control system 22 for controlling the phase of the primary interference fringes 18. The fringe control system 22 is provided with a reference grating 24 placed in the area of the recording plane 20 for producing Moiré fringes 26 having a phase. The fringe control system 22 also has a Moiré fringes sensing device 28 exposed to the Moiré fringes 26 for sensing the phase of the Moiré fringes 26. The Moiré fringes sensing device 28 is also provided with processing means 30, preferably a computer or a convenient electronic system, connected to the Moiré fringes sensing device 28 for processing the phase of the Moiré fringes 26, thereby locking the phase of the primary fringes 18 relative to the recording plate 12 during an exposure of the recording plate 12 to the primary fringes 18 and shifting the phase of the primary fringes 18 between multiple exposures of the recording plate 12 to the primary fringes 18. The holographic set-up 10 finally has a phase shifting device 32 connected to the processing means 30 for shifting a phase of one of the laser beams 14, 16, thereby shifting the phase of the primary fringes 18 in the recording plane 20. Preferably, the phase shifting device 32 comprises a moving mirror 34 extending in a path of one of the laser beams 14, 16 for shifting the phase of the laser beam. The holographic set-up 10 may also advantageously be provided with optional lenses 36, 38 for expanding the laser beams 14, 16 in a convenient manner.

In a preferred embodiment, the Moiré fringes sensing device 28 comprises a locking detector 40 mounted on a translation stage 42 and sending an error signal to the phase shifting device 32 in order to maintain the Moiré fringes 26 fixed relative to the locking detector 40 and simultaneously maintain the primary fringes 18 fixed relative to the recording plate 12 during exposure.

In another preferred embodiment, the Moiré fringes sensing device 28 further comprises a fixed camera 44 exposed to the Moiré fringes 26 and connected to the processing means 30 for analyzing the Moiré fringes 26 phase with better precision.

In another preferred embodiment, the Moiré fringes sensing device 28 may only include a fixed camera 44. In this case, the camera 44 may be used as the fringe locking detector as explained above in the preferred embodiments of the method of the present invention.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. A method for manufacturing a grating mask having phase shifted regions, said method comprising the steps of:
a) providing a first mask and a second mask, each of said masks having at least one opaque area and at least one transparent area;
b) masking by the first mask a photosensitive substrate for providing a first substrate-mask assembly;
c) placing the first substrate-mask assembly in a recording area of a holographic set-up provided with a plurality of coherent interfering laser beams producing primary interference fringes having a phase;
d) locking the phase of the primary fringes relative to the photosensitive substrate with a fringe control system comprising:
a reference grating placed in the recording area for producing Moiré fringes having a phase;
a Moiré fringes sensing device exposed to the Moiré fringes for sensing the phase of the Moiré fringes;
processing means connected to the Moiré fringes sensing device for processing the phase of the Moiré fringes;
said processing means being connected to a phase shifting device shifting a phase of one of said laser beams for shifting the phase of the primary fringes, thereby locking the phase of the primary fringes relative to the photosensitive substrate during an exposure of the photosensitive substrate;
e) exposing the first substrate-mask assembly to the locked primary fringes of the holographic set-up for recording said primary fringes in the photosensitive substrate through the at least one transparent area of the first mask;
f) stopping exposing;
g) removing the first mask of the photosensitive substrate;
h) masking by the second mask the photosensitive substrate for providing a second substrate-mask assembly;
i) shifting of a predetermined distance the phase of the primary fringes relatively to the photosensitive substrate with the phase shifting device for providing a primary fringes phase shift;
j) locking the phase of the primary fringes relatively to the photosensitive substrate with the fringes control system; and
k) exposing the second substrate-mask assembly to the locked primary fringes of the holographic set-up for recording said primary fringes in the photosensitive substrate through the at least one transparent area of the second mask, thereby providing a grating mask having phase shifted regions.

2. The method according to claim 1, wherein said phase shifting device comprises a moving mirror extending in a path of one of the laser beams for shifting the phase of said laser beam.

3. The method according to claim 1, wherein said Moiré fringes sensing device comprises a locking detector mounted on a translation stage, said step i) of shifting the phase of the primary fringes comprising the substeps of:
sensing an original phase of the Moiré fringes;
translating the locking detector of a predetermined distance in a predetermined plane relatively to the photosensitive substrate;
processing in real time the phase of the Moiré fringes; and
shifting the phase of the primary fringes relative to the photosensitive substrate until said locking detector senses the original phase of the Moiré fringes, thereby stabilizing the phase sensed by the locking detector and providing said primary fringes phase shift.

4. The method according to claim 3, wherein said locking detector is translated in a plane parallel to the photosensitive substrate.

5. The method according to claim 3, wherein said predetermined distance is calculated from a pitch of the Moiré fringes.

6. The method according to claim 3, wherein said Moiré fringes sensing device further comprises a fixed camera exposed to the Moiré fringes and connected to the processing means for analyzing shifting of the Moiré fringes, thereby providing said predetermined distance.

7. The method according to claim 1, wherein said Moiré fringes sensing device comprises a fixed camera, said step i) of shifting the phase of the primary fringes comprising the substeps of:
sensing an original phase of the Moiré fringes; and
shifting the phase of the primary fringes until said camera senses a shift of the original phase corresponding to said primary fringes phase shift.

8. The method according to claim 1, further comprising the steps of:
l) providing at least one additional mask; and
m) repeating steps f) to k) with each of said at least one additional mask.

9. The method according to claim 1, wherein said first and second masks are provided within a single masking element.

10. The method according to claim 1, wherein each of said at least one transparent area of each of said first and second masks is a clear opening.

11. The method according to claim 1, wherein each of said at least one transparent area of the first mask is masked by one of the at least one opaque region of the second mask.

12. The method according to claim 1, wherein said Moiré fringes have a periodicity comprised between 2 mm and 5 mm.

13. The method according to claim 1, wherein said grating mask is chirped.

14. The method according to claim 13, wherein said grating mask is linearly chirped.

15. The method according to claim 1, wherein said grating mask is unchirped.

16. The method according to claim 1, wherein said grating mask is an apodized grating.

17. The method according to claim 1, wherein said grating mask is a phase mask for manufacturing a Bragg grating.

18. The method according to claim 1, wherein said photosensitive substrate is a photoresist coated substrate.

19. The method according to claim 1, wherein said photosensitive substrate is made of material selected from group consisting of silica, silicon, glass, magnesium fluoride, calcium fluoride and zinc selenide.

20. A holographic set-up for manufacturing a grating mask having phase shifted regions, on a recording plate, said holographic set-up comprising:
a plurality of coherent interfering laser beams producing primary interference fringes having a phase in a recording plane, said recording plate being coincident to the recording plane;
a fringe control system for controlling the phase of the primary interference fringes comprising:
a reference grating placed in the recording plane for producing Moiré fringes having a phase;
a Moiré fringes sensing device exposed to the Moiré fringes for sensing the phase of the Moiré fringes; and
processing means connected to the Moiré fringes sensing device for processing the phase of the Moiré fringes, thereby locking the phase of the primary fringes relative to the recording plate during an exposure of the recording plate to the primary fringes and shifting said phase of said primary fringes between multiple exposures of the recording plate to the primary fringes; and
a phase shifting device connected to the processing means for shifting a phase of one of the laser beams, thereby shifting the phase of the primary fringes in the recording plane.

21. The holographic set-up according to claim 20, wherein said phase shifting device comprises a moving mirror extending in a path of one of the laser beams for shifting the phase of said laser beam.

22. The holographic set-up according to claim 20, wherein said Moiré fringes sensing device comprises a locking detector mounted on a translation stage.

23. The holographic set-up according to claim 22, wherein said Moiré fringes sensing device further comprises a fixed camera exposed to the Moiré fringes and connected to the processing means for analysing shifting of the Moiré fringes.

24. The holographic set-up according to claim 20, wherein said Moiré fringes sensing device comprises a fixed camera.
